(19) United States
(12) Patent Application Publication
(10) Pub. No.: US 2025/0108926 A1
(43) Pub. Date: Apr. 3, 2025

(54) AIRCRAFT WING OR TAIL ARRANGEMENTS

(71) Applicant: Airbus Operations Limited, FILTON (GB)

(72) Inventor: James BROWN, FILTON (GB)

(21) Appl. No.: 18/896,181

(22) Filed: Sep. 25, 2024

(30) Foreign Application Priority Data
Sep. 29, 2023 (GB) 2314961.0

(51) Int. Cl. B64D 15/08; B64C 3/28

(52) U.S. Cl. CPC B64D 15/08; B64C 3/28

(57) ABSTRACT

An aircraft structural component having an upwardly- or downwardly-extending portion, such as a wing tip or tail fin, comprising one or more outlets for the delivery of anti-icing fluid to a first surface of the aircraft structural component. Anti-icing fluid is delivered through an outlet located at or near the tip of the upwardly-extending portion, or the base of the downwardly-extending portion. The anti-icing fluid thus delivered may, under the influence of gravity, run down the surface of the component, thereby providing the surface of the component with anti-icing fluid.

### CROSS-REFERENCES TO RELATED APPLICATIONS

This application claims the benefit of Great Britain Patent Application Number 2314961.0 filed on Sep. 29, 2023, the entire disclosure of which is incorporated herein by way of reference.

### FIELD OF THE INVENTION

The present invention relates to an aircraft structural component having an upwardly- or downwardly-extending portion, such as a wing tip or tail fin.

The invention also concerns an aircraft wing, an aircraft empennage, an aircraft, a wing tip device, a tail fin and a method of providing anti-icing fluid to a surface of an aircraft wing tip portion or a tail fin.

### BACKGROUND OF THE INVENTION

Icing of aircraft wings and tails may occur in cold weather conditions. Icing of wings in particular is undesirable because it may lead to a loss of lift. Ice may be removed from a surface, or may be prevented from forming, by providing anti-icing fluid to the wing. Such anti-icing fluid is sometimes known as “deicing fluid” or “deicer”. Anti-icing fluid may be provided to an aircraft wing and to a tail by spraying the wing, tail and other parts of the aircraft using a deicing machine, which is typically a ground-based apparatus with an articulated arm on which a sprayer device is mounted. Alternatively or additionally, the leading edge of the main body of the wing may be provided with outlets through which anti-icing fluid is delivered to the leading edge of the wing. The location of the outlets in the main body of the wing means that not all of the wing is provided with anti-icing fluid. Furthermore, the provision of anti-icing fluid to the main body of the wing may not be the most efficient or effective way of providing the wing with anti-icing fluid.

### SUMMARY OF THE INVENTION

The present invention seeks to mitigate the above-mentioned problems. Alternatively or additionally, the present invention seeks to provide an improved aircraft wing arrangement.

In accordance with a first aspect of the present invention, there is provided an aircraft structural component having an upwardly-extending portion, and an anti-icing fluid system comprising at least one fluid outlet for the delivery of anti-icing fluid to a first surface of the upwardly-extending portion of the aircraft structural component.

Preferably, one or more fluid outlets is located proximate to a tip of the upwardly-extending portion.

Alternatively, the invention provides an aircraft structural component having a downwardly-extending portion, and an anti-icing fluid system comprising at least one fluid outlet for the delivery of anti-icing fluid to a first surface of the downwardly-extending portion of the aircraft structural component.

Preferably, one or more outlets is located at proximate to a base of the downwardly-extending portion.

The anti-icing fluid delivered through an outlet located at or near the tip of the upwardly-extending portion, or the base of the downwardly-extending portion may, under the influence of gravity, run down the surface of the component, thereby providing the surface of the component with anti-icing fluid. This may be particularly beneficial because anti-icing fluid delivered to a wing tip or tail fin by conventional means (for example, by spraying) will have a tendency to run-off, making the wing tip or tail fin more prone to icing. At least one, optionally more than one and optionally each of the outlets may be located in a surface of the wing tip portion or tail fin at, or proximate, to a tip of the aircraft wing tip portion or tail fin.

Advantageously, the anti-icing fluid system includes at least one delivery conduit arranged to deliver anti-icing fluid to the fluid outlet or outlets.

The delivery conduit may be located adjacent a surface of the component.

Preferably, the anti-icing fluid system includes a reservoir for the storage of anti-icing fluid, in communication with the at least one delivery conduit.

The structural component may have a leading edge, and at least one fluid outlet is located at or proximate to the leading edge.

At least one, optionally more than one and optionally each of the outlets may be located at or proximate to a leading edge of the aircraft wing tip portion or tail fin. This is a convenient location for the outlet(s). Anti-icing fluid delivered through an outlet at the leading edge of the wing tip portion or tail fin may, when the aircraft is in motion, spread rearwardly from the leading edge of the wing tip portion or tail fin, providing one or both of an upper and a lower surface of the wing tip portion, or one or both of the port and starboard surfaces of a tail fin, with anti-icing fluid.

The aircraft structural component may have a second surface and at least one fluid outlet arranged to deliver anti-icing fluid to the second surface. Optionally, at least one of such outlets may be associated with a first surface of the aircraft wing tip portion or tail fin such that anti-icing fluid delivered through said outlet is delivered to the first surface. The at least one of such outlets may be located in the first surface. Optionally, at least one of such outlets may be associated with a second surface of the aircraft wing tip portion or tail fin (the second surface not being the first surface) such that anti-icing fluid delivered through said outlet is delivered to the second surface. The at least one of such outlets may be located in the second surface. This may facilitate the delivery of anti-icing fluid to different surfaces of a wing tip portion or tail fin. For example, the first and second surface may be mutually-opposed surfaces of the wing tip portion or tail fin.

The aircraft structural component may take the form of a wing tip.

The wing tip may comprise a wing tip device. A wing tip device may be provided to reduce drag. Alternatively, a wing tip device may be a foldable wing tip device that is operable between a folded configuration and an extended configuration, wherein in, in the folded configuration, a portion of the wing tip device is an upwardly-extending portion. The wing tip device may be a winglet. The winglet may be blended or canted. The wing tip device may be an upwardly-extending winglet (sometimes called a “sharklet”), a foldable wing tip, a split winglet (with upwardly-extending and downwardly-extending winglet portions) or a wingtip fence.

The aircraft structural component may take the form of a tail fin.

The wing tip portion or tail fin may comprise an upwardly-extending portion. The wing tip portion or tail fin may comprise a downwardly-extending portion. The wing tip portion or tail fin may comprise an upwardly-extending portion and a downwardly-extending portion, for example, a scimitar winglet or a wingtip fence, in the case of a wing tip device. The downwardly-extending portion may optionally project from the upwardly-extending portion. For example, a sharklet may comprise an upwardly-extending portion. A wing tip portion comprising a scimitar winglet may comprise an upwardly-extending portion and a downwardly-extending portion.

The tail fin may, for example, be a vertical tail fin (for example, when the aircraft is at rest in a conventional orientation the tail fin is approximately vertical). The tail fin may be at an angle to the vertical when the aircraft is at rest in a conventional orientation. The aircraft may comprise one, and only one, tail fin. The aircraft may optionally comprise more than one tail fin.

The aircraft wing arrangement may comprise an inboard aircraft wing portion inboard of the aircraft wing tip portion. The inboard aircraft wing portion may optionally be contiguous with the aircraft wing tip portion. The inboard aircraft wing portion may optionally comprise one or more exits for the delivery of anti-icing fluid to a surface of the inboard aircraft wing portion.

The aircraft tail arrangement may comprise a portion of aircraft fuselage to which the tail fin is attached.

The tail fin may comprise a tail fin root for attaching the tail fin to other parts of an aircraft empennage, for example, a rear part of an aircraft fuselage.

According to a second aspect of the invention there is also provided an aircraft wing comprising an aircraft structural component according to the first aspect of the invention.

The aircraft wing may comprise a wing root.

The aircraft wing may comprise a wing box. The wing box typically provides structural integrity to the wing. The aircraft wing may comprise one or more spars and one or more ribs.

The aircraft wing may optionally have length of at least 15 m, optionally at least 20 m, optionally at least 25 m, optionally at least 30 m and optionally at least 35 m.

The aircraft wing may optionally be an aircraft wing for a narrow body or a wide body aircraft. The aircraft wing may optionally be an aircraft wing for a twin-engine aircraft or a four-engine aircraft. The aircraft wing may comprise structural support members for supporting a single aircraft engine. The aircraft wing may comprise structural support members for supporting more than one, and optionally only two, aircraft engines.

According to a third aspect of the invention there is also provided an aircraft empennage comprising an aircraft structural component in accordance with the first aspect of the present invention.

The aircraft empennage may comprise one or more tailplanes.

The tail fin may be attached to an aircraft fuselage.

In accordance with a fourth aspect of the present invention, there is provided an aircraft comprising one or more aircraft wing arrangements in accordance with the first aspect of the present invention, a tail arrangement in accordance with the first aspect of the present invention, one or more aircraft wings in accordance with the second aspect of the present invention and/or an aircraft empennage in accordance with the third aspect of the present invention

The aircraft may optionally be a single aisle aircraft. The aircraft may optionally be a double aisle aircraft.

The aircraft may optionally have a wingspan of at least 30 m, optionally at least 35 m, optionally at least 40 m and optionally at least 45 m.

In accordance with a fifth aspect of the present invention, there is provided a wing tip device for the aircraft wing arrangement of the first aspect of the present invention. The wing tip device of the fifth aspect of the present invention may comprise one or more features of the wing tip portion described above in relation to the aircraft wing arrangement of the first aspect of the present invention. In this connection, the wing tip device of the fifth aspect of the present invention may comprise an inboard portion for attachment to an outboard portion of an inboard aircraft wing portion. The wing tip device may comprise one or more outlets for the delivery of anti-icing fluid to a surface of the wing tip device. The wing tip device may comprise a plurality of outlets for the delivery of anti-icing fluid to a surface of the wing tip device. At least one, optionally more than one and optionally each outlet may be located at, or proximate (i.e., closer than an opposite edge) to, a leading edge of the wing tip device. The wing tip device may comprise a fluid delivery arrangement for delivering anti-icing fluid to at least one, optionally more than one and optionally each outlet. The fluid delivery arrangement may optionally comprise one or more conduits for the delivery of anti-icing fluid to at least one, more than one and optionally each outlet.

The wing tip device may comprise an upwardly-extending portion. The wing tip device may comprise a downwardly-extending portion. The wing tip device may comprise an upwardly-extending portion and a downwardly-extending portion, for example, scimitar winglets or a wingtip fence. For example, the downwardly-extending portion may project from the upwardly-extending portion. For example, a sharklet may comprise an upwardly-extending portion. A wing tip device comprising a scimitar winglet may comprise an upwardly-extending portion and a downwardly-extending portion.

One or more outlets may be provided for the delivery of anti-icing fluid to a surface of an upwardly-extending portion of the wing tip device. An upwardly-extending portion of the wing tip device may optionally be provided with one or more outlets for the delivery of anti-icing fluid to a surface the upwardly-extending portion of the wing tip device. It may be beneficial to deliver anti-icing fluid to a surface of an upwardly-extending portion of the wing tip device because the anti-icing fluid may, under the influence of gravity, fall down the upwardly-extending portion onto other portions of the aircraft wing arrangement.

One or more outlets may be provided for the delivery of anti-icing fluid to a surface of a downwardly-extending portion of the wing tip device. A downwardly-extending portion of the wing tip device may optionally be provided with one or more outlets for the delivery of anti-icing fluid to a surface the downwardly-extending portion of the wing tip device.

The wing tip device may be operable between a folded configuration and an extended configuration. In the folded configuration, the length of the aircraft wing arrangement is shorter than in the extended configuration. In the folded configuration, a portion of the wing tip device may be an upwardly-extending portion. In the extended configuration, said portion of the wing tip device may be not upwardly-extending.

In accordance with a sixth aspect of the present invention, there is provided a tail fin for the aircraft tail arrangement of the first aspect of the present invention. The tail fin of the sixth aspect of the present invention may comprise one or more features of the tail fin described above in relation to the aircraft tail arrangement of the first aspect of the present invention.

In accordance with a further aspect of the present invention, there is provided a method of delivering anti-icing fluid to a surface of an aircraft structural component having an upwardly- or downwardly-extending portion, the method comprising delivering anti-icing fluid to a first surface of the upwardly- or downwardly-extending portion through at least one outlet provided in the component.

It will of course be appreciated that features described in relation to one aspect of the present invention may be incorporated into other aspects of the present invention. For example, the method of the invention may incorporate any of the features described with reference to the apparatus of the invention and vice versa.

### BRIEF DESCRIPTION OF THE DRAWINGS

Embodiments of the present invention will now be described by way of example only with reference to the accompanying schematic drawings of which:

FIG. 1A shows a schematic front-on view of an example of an aircraft wing arrangement according to a first embodiment of the invention, in which a wing tip device is in a folded configuration;

FIG. 1B shows a schematic front-on view of an example of an aircraft wing arrangement according to a first embodiment of the invention, in which the wing tip device is in an extended configuration;

FIG. 2 shows a schematic plan view of the aircraft wing arrangement of FIGS. 1A and 1B, in which the wing tip device is in an extended configuration;

FIG. 3 shows a schematic plan view of an example of an aircraft according to an embodiment of the invention;

FIG. 4 shows a schematic front-on view of an example of an aircraft wing arrangement according to another embodiment of the invention;

FIG. 5 shows a schematic front-on view of an example of an aircraft wing arrangement according to yet another embodiment of the invention;

FIG. 6 shows a schematic front-on view of an example of an aircraft wing arrangement according to a further embodiment of the invention;

FIG. 7 shows a schematic representation of a method of providing anti-icing fluid to a wing tip device according to another embodiment of the invention; and

FIG. 8 shows a schematic representation of an example of an aircraft tail arrangement and empennage according to another embodiment of the invention.

### DETAILED DESCRIPTION OF THE PREFERRED EMBODIMENTS

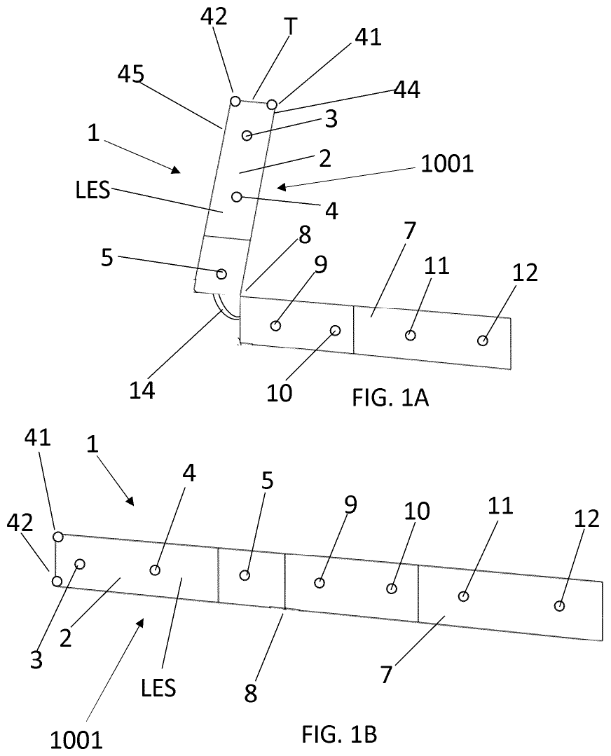

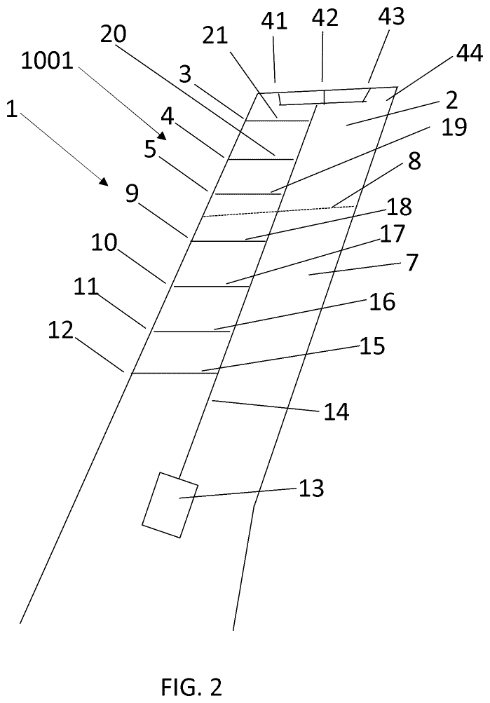

An example of an aircraft structural component in the form of a wing will now be described with reference to FIGS. 1A, 1B and 2. The aircraft wing arrangement is denoted generally by reference numeral 1, and comprises an aircraft wing tip portion 1001 comprising an aircraft wing tip device 2 and one or more outlets 3, 4, 5, 41, 42, 43 for the delivery of anti-icing fluid to one or more surface of the wing tip device 2. The wing tip device 2 is a folding wingtip which is movable about hinge 8 between a folded configuration as shown in FIG. 1A and an extended configuration as shown in FIG. 1B. Such folding wingtips are known to those skilled in the art. Outlets 3, 4, 5 for the delivery of anti-icing fluid are provided in the leading edge surface LES of wing tip device 2. Outlets 41, 42, 43 for the delivery of anti-icing fluid are provided at the tip T of wing tip device 2. Referring to FIG. 2, anti-icing fluid is delivered from reservoir 13 via conduit 14 to conduits 21, 20, 19 to outlets 3, 4, 5 provided in the surface LES of the leading edge of wing tip device 2. Anti-icing fluid is delivered from reservoir 13 via conduit 14 to outlets 41, 42, 43 provided at the tip T of wing tip device 2. Outlets 41, 43 are associated with surface 44 of wing tip device 2 such that anti-icing fluid delivered via outlets 41, 43 is delivered to surface 44. Outlet 42 is associated with surface 45 of wing tip device 2 such that anti-icing fluid delivered via outlet 42 is delivered to surface 45.

Anti-icing fluid inhibits the formation of ice on the wing tip device 2, and may facilitate the removal of some or all ice present on the wing tip device 2, by suppressing the melting point (and therefore the freezing point) of the solution formed by dissolving anti-icing fluid in water. Forwards movement of the aircraft of which the aircraft wing arrangement 1 is part causes dispersal of anti-icing fluid from the leading edge surface LES rearwards over the wing tip device 2. Furthermore, when the wing tip device 2 is in the folded configuration as shown in FIG. 1A, anti-icing fluid dispensed from outlets 41, 42, 43 may run down the upwardly-projecting wing tip device 2, providing anti-icing fluid to the surfaces 44, 45 of the wing tip device.

Aircraft wing arrangement 1 comprises an inboard wing portion 7 to which the wing tip device 2 is attached via hinge 8. Inboard wing portion 7 comprises exits 9, 10, 11, 12 for the delivery of anti-icing fluid to the leading edge surface of the inboard wing portion 7. Referring to FIG. 2, anti-icing fluid is delivered from reservoir 13 via conduit 14 and via conduits 18, 17, 16, 15 to exits 9, 10, 11, 12 provided in the leading edge surface of inboard wing portion 7.

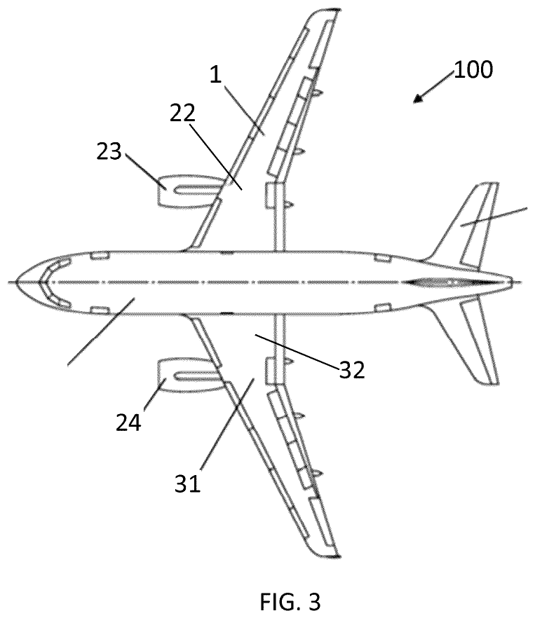

An example of an aircraft in accordance with a further embodiment of the present invention will now be described with reference to FIG. 3. The aircraft is denoted generally by reference numeral 100, and comprises a first wing 22 comprising the aircraft wing arrangement 1 described above with reference to FIGS. 1A, 1B and 2, and a second wing 32 comprising an aircraft wing arrangement 31 that is essentially the same as aircraft wing arrangement 1, but configured for the port wing and not the starboard wing. Both the first 22 and second 32 wings are provided with engines 23, 24. The aircraft is a single-aisle, twin-engine short haul aircraft.

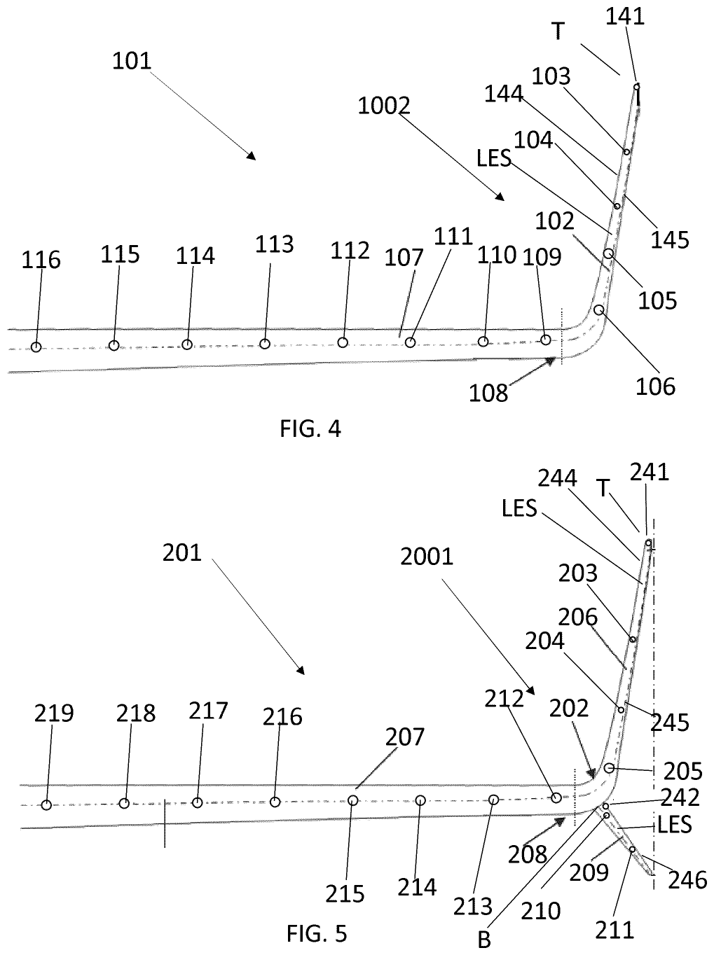

A further example of an aircraft wing arrangement in accordance with a further embodiment of the invention will now be described with reference to FIG. 4. The aircraft wing arrangement is denoted generally by reference numeral 101, and comprises an aircraft wing tip portion 1002 comprising an aircraft wing tip device 102 and one or more outlets 103, 104, 105, 106, 141 for the delivery of anti-icing fluid to one or more surfaces of the wing tip device 102. The wing tip device 102 is a winglet that is attached at line 108 to an inboard wing portion 107. Such winglets are known to those skilled in the art. The winglet extends upwardly from the attachment line 108, with winglet tip T being displaced from the inboard wing portion 107 so that vortices generated at the winglet tip T create less drag. Outlets 103, 104, 105, 106 for the delivery of anti-icing fluid are provided in the leading edge surface LES of wing tip device 102. Outlet 141 is provided in the tip T of the winglet. As described above in relation to FIG. 2, anti-icing fluid is delivered from a reservoir (not shown) via conduits (now shown) to outlets 103, 104, 105, 106 provided in the surface LES of the leading edge of wing tip device 102, and to outlet 141 provided in the tip T. Forwards movement of the aircraft of which the wing arrangement 101 is part causes dispersal of anti-icing fluid from the leading edge surface LES rearwards over the surface of the wing tip device 102. Anti-icing fluid delivered via outlet 141 falls under the influence of gravity to provide surfaces 144, 145 with anti-icing fluid.

Aircraft wing arrangement 101 comprises an inboard wing portion 107 to which the wing tip device 102 is attached at attachment line 108. Inboard wing portion 107 comprises exits 109-116 for the delivery of anti-icing fluid to the leading edge surface of the inboard wing portion 107. As described above in relation to FIG. 2, anti-icing fluid is delivered from a reservoir (not shown) via conduits (not shown) to exits 109-116 provided in the leading edge surface of inboard wing portion 107.

A yet further example of an aircraft wing arrangement in accordance with another embodiment of the invention will now be described with reference to FIG. 5. The aircraft wing arrangement is denoted generally by reference numeral 201, and comprises an aircraft wing tip portion 2001 comprising an aircraft wing tip device 202 and one or more outlets 203, 204, 205, 210, 211, 241, 242 for the delivery of anti-icing fluid to one or more surfaces of the wing tip device 202. The wing tip device 202 is a split winglet that is attached at line 208 to an inboard wing portion 207. Split winglet 202 comprises an upwardly-extending winglet portion 206 and a downwardly-extending winglet portion 209. Such split winglets are known to those skilled in the art. Outlets 203, 204, 205 for the delivery of anti-icing fluid are provided in the leading edge surface LES of upwardly-extending winglet portion 206. Outlets 210, 211 are provided in the leading edge surface LES of downwardly-extending winglet portion 209. Outlet 241 is provided at tip T of upwardly-extending winglet portion 206. Outlet 242 is provided at base B of downwardly-extending winglet portion 209. As described above in relation to FIG. 2, anti-icing fluid is delivered from a reservoir (not shown) via conduits (not shown) to outlets 203, 204, 205, 210, 211, 241, 242.

Forwards movement of the aircraft of which the wing arrangement 201 is part causes dispersal of anti-icing fluid from the leading edge surface LES rearwards over the surface of the wing tip device 202. Anti-icing fluid delivered via outlet 241 falls under the influence of gravity to provide surfaces 244, 445 with anti-icing fluid. Anti-icing fluid delivered via outlet 242 falls under the influence of gravity to provide surface 246 with anti-icing fluid.

Aircraft wing arrangement 201 comprises an inboard wing portion 207 to which the wing tip device 202 is attached at attachment line 208. Inboard wing portion 207 comprises exits 212-219 for the delivery of anti-icing fluid to the leading edge surface of the inboard wing portion 207. As described above in relation to FIG. 2, anti-icing fluid is delivered from a reservoir via conduits to exits 212-219 provided in the leading edge surface of inboard wing portion 207.

The aircraft wing arrangements 1, 101, 201 also describe example of embodiments of wing tip devices in accordance with the present invention.

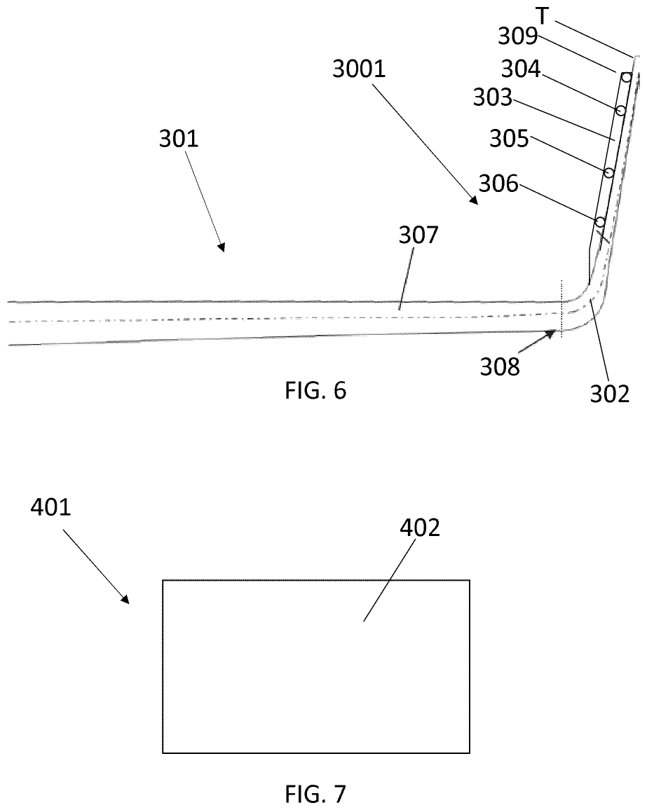

A further aircraft wing arrangement in accordance with even yet another embodiment of the invention will now be described with reference to FIG. 6. The aircraft wing arrangement is denoted generally by reference numeral 301 and comprises an aircraft wing tip portion 3001 comprising an aircraft wing tip device 302 and one or more outlets 304, 305, 306, 309 for the delivery of anti-icing fluid to one or more surfaces of wing tip device 302. Outlets 304, 305, 306, 309 are formed in a delivery conduit 303 attached to a surface of the wing tip device 302. A portion of the delivery conduit 303 comprising outlets 304, 305, 306 is adjacent to the leading edge of the wing tip device 302. A portion of the delivery conduit 303 comprising outlet 309 extends rearwardly from the leading edge of the wingtip device such that outlet 309 is located adjacent tip T in a relatively central position such that anti-icing fluid delivered via outlet 309 falls under the action of gravity onto the upper surface of the wing tip device 302. The wing tip device 302 is a winglet that is attached at line 308 to an inboard wing portion 307. The winglet extends upwardly from the attachment line 308, with winglet tip T being displaced from the inboard wing portion 307 so that vortices generated at the winglet tip T create less drag. Anti-icing fluid is delivered from a reservoir via conduits via delivery conduit 303 to outlets 304, 305, 306 provided in delivery conduit 303. Forwards movement of the aircraft of which the wing arrangement 301 is part causes dispersal of anti-icing fluid from the leading edge surface rearwards over the surface of the wing tip device 302.

A method of delivering anti-icing fluid to a surface of a wing tip device will now be described by way of example only, with reference to FIG. 7. The method is denoted generally by reference numeral 401, the method 401 comprising providing 402 anti-icing fluid to a surface of the wing tip device through an outlet provided in the wing tip device. The wing tip device may be any suitable wing tip device, such as wing tip devices 2, 102, 202 described above. The method 401 may comprise providing anti-icing fluid through a plurality of outlets provided in the wing tip device. Anti-icing fluids are well-known to those skilled in the art. For example, glycol-based anti-icing fluids are known.

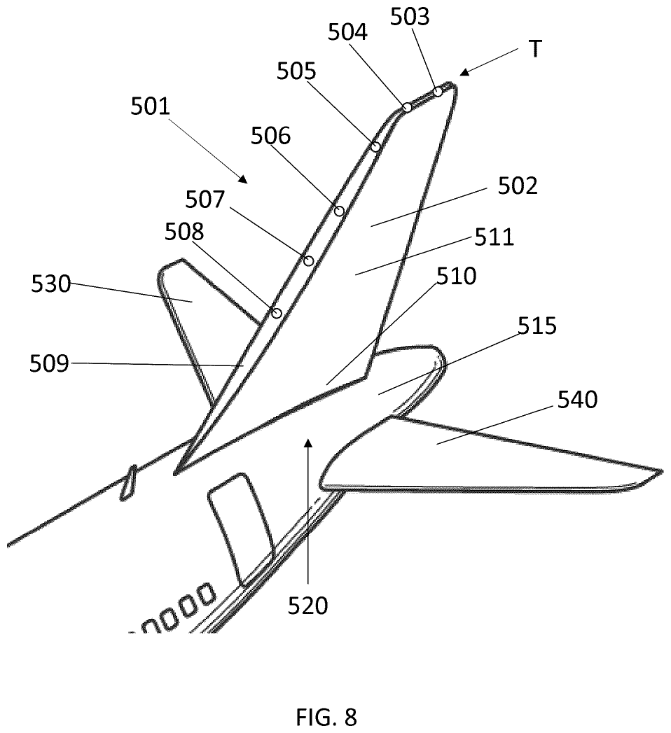

The examples above describe various embodiments of aircraft wing arrangements in accordance with the present invention. An example of an aircraft tail arrangement, a tail fin and aircraft empennage in accordance with a further embodiment of the invention will now be described with reference to FIG. 8. The aircraft tail arrangement is denoted generally by reference numeral 501, and comprises an aircraft tail fin 502 and one or more outlets 503, 504, 505, 506, 507, 508 for the delivery of anti-icing fluid to one or more surfaces of the tail fin 502. The tail fin 502 is a standard vertical tail fin that is attached at its root 510 to a rear portion of fuselage 515. Such tail fins are known to those skilled in the art. The tail fin 502 extends upwardly from root 510 to tip T. Outlets 505, 506, 507, 508 for the delivery of anti-icing fluid are provided in the leading edge surface 509 of tail fin 502. Outlets 503, 504 are provided in the tip T of the tail fin. As described above in relation to FIG. 2, anti-icing fluid is delivered from a reservoir (not shown) via conduits (now shown) to outlets 505, 506, 507, 508 provided in the surface of the leading edge 509 of tail fin 502, and to outlets 503, 504 provided in the tip T. Forwards movement of the aircraft of which the tail arrangement 501 is part causes dispersal of anti-icing fluid from the leading edge surface 509 rearwards over the starboard and port surfaces of tail fin 502, the port surface being labelled 511. Anti-icing fluid delivered via outlets 503, 504 falls under the influence of gravity to provide the starboard and port 511 surfaces with anti-icing fluid.

Aircraft empennage 520 comprises aircraft tail arrangement 502, fuselage 515 and tailplanes 530, 540. Fuselage 515 and tailplanes 530, 540 are conventional and known to those skilled in the art.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

The Examples above demonstrate the provision of anti-icing fluid to the surfaces of various wing tip devices. Those of ordinary skill in the art will realize that the present invention may be used with other wing tip devices, such as those comprising a wingtip fence or a canted wingtip.

The Examples above illustrate the provision of anti-icing fluid to the surfaces of various wing tip devices. Those skilled in the art will realize that the present invention may be used with a conventional aircraft wing tip.

The Examples above demonstrate aircraft wing arrangements according to the present invention for a single aisle, twin-engine aircraft. Those of ordinary skill in the art will realize that the present invention may be used on different aircraft, such as smaller aircraft, which may typically only have a single engine and a smaller wingspan, and larger aircraft, which may optionally have two or four engines and a larger wingspan.

The Example above relating to a tail fin tip describes an aircraft tail arrangement with a single, vertical tail fin attached to a fuselage. Those of ordinary skill in the art will realize that other arrangements are possible. For example, the aircraft tail arrangement may comprise two tail fins. One or more of those tail fins may not be vertical, for example. One or more tail fin may optionally be attached to a tailplane.

The Examples above describe the outlets for the anti-icing fluid being provided in the leading edge of the wing, at a wing tip or at a tail fin tip. Those of ordinary skill in the art will realize that the outlets may be located elsewhere.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. An aircraft structural component comprising:
an upwardly-extending portion, and
an anti-icing fluid system comprising at least one fluid outlet for delivery of an anti-icing fluid to a first surface of the upwardly-extending portion of the aircraft structural component.

2. The aircraft structural component as claimed in claim 1, further comprising:
one or more fluid outlets located proximate to a tip of the upwardly-extending portion.

3. An aircraft structural component comprising:
a downwardly-extending portion, and
an anti-icing fluid system comprising at least one fluid outlet for delivery of an anti-icing fluid to a first surface of the downwardly-extending portion of the aircraft structural component.

4. The aircraft structural component as claimed in claim 3, further comprising:
one or more outlets located at proximate to a base of the downwardly-extending portion.

5. The aircraft structural component as claimed in claim 1, wherein the anti-icing fluid system includes at least one delivery conduit configured to deliver the anti-icing fluid to the at least one fluid outlet.

6. The aircraft structural component as claimed in claim 5, wherein the at least one delivery conduit is located adjacent a surface of the component.

7. The aircraft structural component as claimed in claim 1, wherein the anti-icing fluid system includes a reservoir for storing the anti-icing fluid, the reservoir in communication with at least one delivery conduit.

8. The aircraft structural component as claimed in claim 1, wherein the aircraft structural component has a leading edge, and the at least one fluid outlet is located at or proximate to the leading edge.

9. The aircraft structural component as claimed in claim 1, wherein the aircraft structural component has a second surface with the at least one fluid outlet arranged to deliver anti-icing fluid to the second surface.

10. The aircraft structural component as claimed in claim 1, wherein the aircraft structural component comprises a wing tip.

11. The aircraft structural component as claimed in claim 10, wherein the wing tip comprises a wing tip device operable between a folded configuration and an extended configuration,
wherein in, in the folded configuration, a portion of the wing tip device comprises the upwardly-extending portion.

12. An aircraft wing comprising:
the aircraft structural component as claimed in claim 1.

13. An aircraft comprising:
at least one wing according to claim 12.

14. The aircraft structural component as claimed in claim 1, wherein aircraft structural component comprises a tail fin.

15. An aircraft empennage comprising:
the tail fin as claimed in claim 14.

16. An aircraft comprising:
the aircraft empennage in accordance with claim 15.

17. A method of delivering anti-icing fluid to a surface of an aircraft structural component having an upwardly- or downwardly-extending portion, the method comprising:
delivering anti-icing fluid to a first surface of the upwardly- or downwardly-extending portion through at least one outlet provided in the aircraft structural component.
